(19) United States
(12) Patent Application Publication
(10) Pub. No.: US 2009/0109130 A1
(43) Pub. Date: Apr. 30, 2009

(54) Methods and apparatus for interactive movable computer mediated information display

(76) Inventors: Terence J. Murphy, Pensacola, FL (US); Matthew C. Browning, Philadelphia, PA (US)

Correspondence Address: TERENCE JOHN MURPHY, 7220 THOR LANE, PENSACOLA, FL, 32526, US

(21) Appl. No.: 11/932,382

(22) Filed: Oct. 31, 2007

(51) Int. Cl. G09G 3/00; H02J 17/00

(52) U.S. Cl. 345/31; 307/104

(57) ABSTRACT

In embodiments, methods and systems are presented for physical interaction with computer-mediated information. A movable display module (including a touch screen monitor, CPU, absolute encoder and other sensors, and wireless network connection) is mounted on and can be moved along rails. The rails serve four purposes relating to the movable display module:
1) to provide DC power and/or data through the rails to the equipment;
2) to act as a rack gear for absolute encoding of physical position;
3) to provide physical support;
4) to act as guide tracks.
   As the display module slides along the rails, a computer program receives positional and other sensor data. The program maps the sensor data to programmatic content, and presents said content on the display module or on other displays or in external effects such as lights or robotics. The entire system is designed for reliability, affordability, and ease of mass production.

### CROSS-REFERENCE TO RELATED APPLICATIONS

Not applicable.

### FEDERALLY SPONSORED RESEARCH

Not applicable.

The following is the logical description and flow of the software programs required to run a first embodiment of the current invention. This information appears in flowchart form in FIGS. 8, 9, and 10. The software contains several programs for different tasks, as noted. In other embodiments, similar routines may control other aspects of the embodiments.

Measurement Program: The Measurement Program is a software program used to measure the range of motion the movable display module will travel, and mark its endpoints. In order to calibrate the software so that it is aware of its position on the track, the measurement software must be run so that the left endpoint and right endpoint numeric encoder positions of the track can be determined. Once the left and right endpoint positions have been recorded, the software will know the physical position of the movable display module along the rails, even if the unit loses power. The position is stored in a text file that is read by the Control Program. This needs to be done once when the device is first activated, and again if the movable display module is removed for service.

Start Application:

100. Establish communication with encoder. Open the communication port and protocol for the reading/writing of data to/from the encoder. This includes, but is not limited to: serial RS232, RS485, and TCP/IP.
101. User Input—Slide the movable display module in each direction along the track. When the user physically moves the movable display module back and forth on the track, the encoder updates the current position.
102. Request/Read encoder position. A request message is sent to the encoder, and the reply message is parsed to decipher the numeric encoder position value, stored as an integer.
103. Display encoder position on screen. The user interface of the program displays the last known (current) numeric encoder position, as well as the values in memory of the “leftPoint” and “rightPoint” variables defined by user input (104 and 105).
104. User Input—“Save Left End Point Position”. The user slides the movable display module to the leftmost physical endpoint and clicks a graphical button on the touch screen interface to mark the current encoder position as the “Left Point” on the track. This position data is updated in the measurement program memory and displayed on the interface screen. This user input also triggers the recording of this information into a text file (106) as “leftPoint”.
105. User Input—“Save Right End Point Position”. The user slides the movable display module to the rightmost physical endpoint and clicks a button on the interface to mark the current encoder position as the “Right Point” on the track. This position data is updated in the measurement program memory and displayed on the interface screen. This user input also triggers the recording of this information into a text file (106) as “rightPoint”.
106. Write leftPoint and rightPoint data to text file. This records the two marked encoder positions into a text file for future reading by the system's Control Program (see next listing, and in flowchart form in FIGS. 9 and 10).

Control Program: The Control Program controls the display of information based on the position of the movable display module, using the stored position data from the Measurement Program. The Control Program also requests data from external sensors and inputs, and controls digital and analog outputs. Additionally, the Control Program reacts to user interface commands or input via other sensors, including but not limited to touch screen input, smart card reads, and image or voice capture.

Start Application

110. Read range measurement text file
110a. Open text file with stored “leftPoint”/“rightPoint” encoder positions
110b. Read and store in memory the numeric positions
111. Determine total rail length
111a. Determine the numeric track length in encoder units by subtracting the “leftPoint” from the “rightPoint”.
111b. The resulting number is the total number of encoder units that the movable display module may traverse along the rails. Store this number in memory.
   112. Establish communication with encoder. Open the communication port and protocol for the reading/writing of data to/from the encoder. This communication may include, but is not limited to: serial RS232, RS485, USB, and TCP/IP.
   113. Establish communication with load cells: Open the communication port and protocol for the reading of data from the load cells. This communication may include, but is not limited to: serial RS232, RS485, USB, and TCP/IP. These signals may be routed through an analog to digital input signal converter.
   114. Calibrate load cell reading
114a. Send a request message to the load cell input and read the numeric load cell reading.
114b. Repeat 100 times to determine a statistical average input.
114c. Use this numeric average as a baseline to compare future input readings against.
114d. This process may be repeated periodically by the software.
   115. Establish communication with other external devices as needed. These external devices include, but not limited to: external monitors, media playback devices, motion controllers, actuators, sensors, Radio Frequency Identify (RFID) readers, barcode scanners, microprocessors, video input devices, lighting controllers, digital input/output controllers, and robotics. Communication methods may vary depending on situation.
   116. Establish communication with network devices. These may include, but not limited to: Internet and Local Area Network (LAN) servers, web services, syndication feeds, databases, mobile devices such as cellphones or small computers, and remote video/audio/multimedia. Communication methods may vary depending on situation.
   117. Request/Read encoder position
117a. A request message is sent to the encoder, and the reply message is parsed to decipher the numeric encoder position value.
117b. Store results in memory for use during determination process (123)
   118. Request/Read load cell input
118a. A request message is sent to the load cell, and the reply message is parsed to decipher the numeric load cell input.
118b. Store results in memory for use during determination process (123)

### 119. Request/Read External Input Devices

119a. The appropriate messages are sent to all external input devices, such as sensors, RFID/barcode devices, video input, buttons, etc.
119b. Store results in memory for use during determination process (123)
   120. Request/Read Network Input devices
120a. The appropriate messages are sent to all external network inputs, such as web services, feeds, video, database, etc.
120b. Store results in memory for use in determination process (123)
   121. Request/Read User Input. Record any user input, for example, touch screen input, image capture, or smart card swipes.
   122. Determine current position along track
122a. Subtract the saved “leftPoint” encoder position from the current position to determine the relative position.
122b. Determine the percentage moved by dividing the relative position by the total track length measurement.
122c. Store results in memory for use during determination process (123)
   123. Determine display content based on new input parameters above. Depending on the software content, this step uses the stored input from all input devices to determine how to update the display content on the movable display module, as well as external output and network devices. This process will vary based on the application and the combination of sensors and external devices.
   124. Update External Output Devices. This step sends command messages to external output devices, such as, but not limited to, turning on/off TTL logic outputs, triggering media players, updating external monitor content, and controlling actuators.
   125. Update External Network DeviceSend command messages to external output devices, such as, but not limited to, update database content, request new content source.
   126. Update display graphics and other content on movable display module.

### BACKGROUND OF THE INVENTION

1. Field of the Invention

The current invention relates generally to physically interactive computer systems that map sensor data gained from human activities and contexts such as gesture, motion, image, audio, ambience, environment and location to computer-mediated information displays and effects. More particularly, the current invention relates to methods and means for making such interactive systems substantially more robust, more capable, more effective, safer, and less expensive. The current invention has uses including, but not limited to: serving as a museum or trade show exhibit platform; an interactive educational platform for classrooms or for executive briefing centers; complex data visualization in medical diagnostics or surgical centers; interactive controls for command and control centers; or an interactive presentation device in commercial venues such as malls, showrooms, or stores.

2. Prior Art

Movable computer display products are useful for relating dynamic, updatable digital information to physical spaces or objects. Movable displays have been built in the past, none of which were patented so far as we can discover. In particular, several earlier movable monitor systems were designed and built for the museum market, by the present inventors and by others. The demand for a movable monitor product, despite the consistent problems with these earlier systems (detailed below), led to the creation of the current invention's first embodiment which is a substantial improvement in design, operation, and structure over the earlier systems detailed below.

1. In 1995, the present first inventor, while working for Maltbie Exhibits, designed and built an X-axis (horizontal) movable monitor at the Christopher Columbus Center in Baltimore Md. The positional encoding was accomplished through a simple encoder that measured the position of a sliding steel tape. This system loses its place when power is lost or turned off, and must be recalibrated upon power restoration. The moving steel tape is also subject to wear over time, causing failures. This system required electrical and data cabling to travel with the monitor in its motion, and in aid of this, used a cable management system. A moving cable system is less robust than a system without moving cables, as continual flexing over time will degrade cables and cause eventual failure. This results in increased maintenance costs and downtime for the device.

2. In 1996, exhibit designer Peter Regla showed a sliding display system with X-axis only motion. Position determination was based on a series of switches rather than an encoder, with a resultant lack of resolution. This exhibit also used flexible power and data cabling and a cable management system, with resultant maintenance problems.

3. The present first inventor designed a Reading Wall exhibit for Xerox PARC in 1998-99, which featured a very large, heavy computer monitor that could be pushed horizontally along a track system, displaying changing content according to where it was along the track. Problems with this system include:

The Reading Wall needed cables and cable guides for power and data to travel along the track with the computer monitor. This meant that the cables had to be run to a moving device over a fairly long run, which often led to cable failure due to repeated bending.

Incremental encoder: the Reading Wall did not have an absolute encoder, but read its position by the relative number of clicks along a track from a starting position (using an incremental encoder). Because the position was relative rather than absolute, the system needed to be recalibrated each time it was turned on, and in the event of power failure. No onboard computer. The Reading Wall's moving monitor (a large plasma screen) did not have an onboard computer for handling programmatic content and mapping of input to output; it only had a small microprocessor (a Basic Stamp) that read the track position. Thus the unit was not self-contained but required a computer to be installed somewhere near it and have data cables run to it.

Large, heavy mass and support framework: the Reading Wall used large plasma monitors, which were heavy for users to drag along the track and which required heavy-duty support systems. The plasma monitors and the required supports were large and expensive.

Expensive and non-robust braking: Large and heavy displays in motion need a way to stop them at end of travel. A particle brake and shock system was used in the design for the Reading Wall. Particle brakes are costly, have high drag when not engaged (and therefore make the system harder to use), and are a repeated source of failure in respect to the gear engagement to the track.

Lack of ease of installation: the Reading Wall system as a whole required several days to install, including cable runs through the ceiling and bolting heavy frameworks to supports, often in both floor and ceiling. The system required installation by experts.

Clunky, complicated look and feel: cable guides that had to travel sixteen or more feet meant a very visible tether attached to the exhibit. Cable management meant visual clutter.

4. The Interactive Wall by Lynch Exhibits in 2002 was a development from the above-mentioned Reading Wall (3). It was essentially the same model with a few refinements such as a higher-resolution monitor and faster computer. However the Interactive Wall had all the problems noted above, with one exception. It did solve one of the cable-run issues by mounting a computer to the back of the plasma monitor; however it still used cables and cable guides for power runs. In fact, the Interactive Wall added another, different failure point by adding the onboard computer, as that configuration used standard hard drives which may fail when continually exposed to motion, especially if the brakes fail causing the hard drives to be subject to hard shocks.

Both the Reading Wall and the Interactive Wall used plasma monitors, which had a high failure rate due to stress on the monitor itself from motion and sudden stops and shocks. This added considerably to maintenance costs.

5. Nogginaut (http://www.nogginaut.com) has a sliding monitor system that is based on the designs noted above from Xerox PARC and Lynch Exhibits. This system is smaller and also adds touch screen interactivity. However this system still uses incremental encoding and places the computer processor external to the display module. It also still uses cabling and cable guides for power and data delivery, with the attendant propensity for failure.

6. The Neutrino data display was first designed and built by Dave Dwyer and Peter Regla for Exhibits Plus in 1996, and is still in use at several museums. It is a computer monitor hanging down from a support system on collapsible rods, that can be moved in X-Y (horizontal and vertical) dimensions within a plane. The Neutrino has been popular and effective as an exhibit, proving the market existed for such a device.

However, the Neutrino is very expensive, is not designed for easy replication, and like other X-Y moving monitor exhibits built since, has a lot of down time and high maintenance requirements. The expense and high maintenance costs put this and similar systems financially out of reach for many uses, like smaller museums or educational centers.

The Neutrino's Y-axis rods are counterweighted with pneumatic actuators with an internal cable encoder (which is an incremental encoder); the X-axis motion is enabled by a hanging rod system with a rack and pinion encoder, also an incremental encoder. Since both of this system's encoders are incremental encoders, not absolute, they require a complex, manual resetting procedure in the case of power loss (made even more complex by the fact that there are two different types of encoder).

The power is 12 VDC supplied to the monitor through its vertical support rods; however the 12 VDC run to the X-axis support system is via a cable and uses a cable management system to move the cable back and forth as required. Where the power exits the vertical rods and runs to the monitor itself is also a cable run; as noted above, cable and cable management systems are prone to failure in high-use situations. Also, the Neutrino system does not have an onboard computer, instead using a wireless link to send video information to the monitor. Thus it still requires a “backstage” support area, rather than being an integrated, standalone unit. Install and calibration time for this system is several days, and must be performed by experts.

Counterweight systems, cables and cable management systems, and hanging control rods do not survive well in environments where a million uses a year is likely; for example, one ten-year-old hanging full-weight off the monitor can cause severe stress to the system. In public exhibit spaces like museums, such stress is a daily possibility. Since the interaction for X-Y systems like this one depends on the very motion that tends to cause breakdown, these systems are inherently prone to failure.

Further problems with all the movable monitor systems noted above include:

Lack of ease of production: All of the above systems were produced as site-specific, custom instances, which added to their cost. They were not designed to be produced in large numbers, since they were too expensive to appeal to a large market.

Lack of ease of assembly and installation: They are time-consuming to assemble and require experts to perform the assembly and installation.

Requiring daily calibration: Incremental encoders require manual resetting every time they lose power, which is a liability in commercial or museum settings where technicians may not be available on a daily basis to restart a system.

Difficult to maintain: The number of subsystems in all these prior art systems that have failure-prone components (counterweight systems, hard drives, cables and cable management systems, particle brakes, plasma monitors) combine to create a system that has frequent, high-cost failures that must be repaired by experts.

In light of all of the foregoing, there exists a need for a system which has substantially increased robustness and fewer points of failure, is considerably less expensive to produce, is easier and safer for people to use, provides increased ease of installation, allows user configurability and adaptability to context, and can reliably be produced in large numbers. Applicants have identified methods and means to accomplish these, as well as other issues and concerns that exist in the art in coming to conceive the subject matter of the present application.

### SUMMARY OF THE INVENTION

In embodiments, methods and systems are presented for robust, wireless physical interaction with computer-mediated information. A movable display module is mounted on and can be moved along rails. The rails serve four purposes:

1. a means for providing DC power and in some embodiments, data, to the equipment inside the movable display module;
2. acting as a rack gear for absolute encoding of physical position of the movable display module along the rails;
3. providing physical support for the movable display module; and
4. acting as guide tracks for the motion of the movable display module.

As a user slides the movable display module along the rails, a computer program interprets the sensor data from the motion and presents the appropriate programmatic content on the display module. Other sensors may contribute to the computer input; and other displays or external effects may be controlled by the computer program as well. The movable display module comprises an enclosure, a touch screen and monitor, CPU, absolute encoder and encoder interface, audio amplifier and speakers, a radio frequency wireless network connection (Wifi) mounted on non-conductive material, and other sensors such as, but not limited to, cameras, smart card readers, and load cells. As a result of the rail system and the inclusion of the wireless data network connection, no cabling is required to travel with the movable display module. The absolute encoder means calibration is not lost on powering down; no daily reset is required. The system as a whole is engineered as an integrated unit, for ease of production and ease of installation. This all has the effect of substantially improving reliability, effectiveness, safety and affordability of the system compared to prior art.

### BRIEF DESCRIPTION OF THE DRAWINGS

A first embodiment(s) of the present invention will be described in detail based on the following figures, wherein:

FIG. 1 is an exemplary illustration of a first embodiment of an interactive information display (movable display module, rails, and support system). It shows in perspective view a movable display module mounted on rails that serve as support and guidance tracks, rack gear for the encoder, and power delivery system. The rails are supported by a set of non-conductive standoffs that may be mounted to a wall, cabinet, or support framework.

FIG. 2 is an exemplary illustration of an exploded view of a movable display module mounted on rails that serve as guidance track, rack gear for the encoder, and power delivery system. The rails are supported by a set of non-conductive standoffs that may be mounted to a wall, cabinet, or support framework.

FIG. 3 is an exemplary illustration of a non-conductive standoff and end cap, without power runs.

FIG. 4 is an exemplary illustration of a non-conductive standoff and end cap, showing channels for power runs cut into the non-conductive material.

FIG. 5 is an exemplary illustration of the rails and the rail support system showing standard-width interior standoffs, the rails 8 and 9 with rail 9 showing gear cuts for the rack gear, the gear encoder, and the power pickup. Close-up cutaway view of the lower rail 9 shows gear cuts. Power pickup unit 20 is shown in exploded view.

FIG. 6 is an exemplary illustration of an exploded view of the nonconductive back plate of the movable display module enclosure, showing the attached wireless network antenna (25) and other components that attach thereto.

FIG. 7 is an exemplary illustration of an exploded view of the front and sides of the enclosure for the movable display module, along with the contents that attach thereto.

FIG. 8 illustrates a logical flow chart of a process for determining system measurements, in accordance with various embodiments.

FIG. 9 illustrates a logical flow chart diagram of a process for a Control Program, in accordance with the embodiments described herein.

FIG. 10 is a continuation of the logical flow chart diagram of a process for a Control Program, begun in FIG. 9.

### REFERENCE NUMERALS

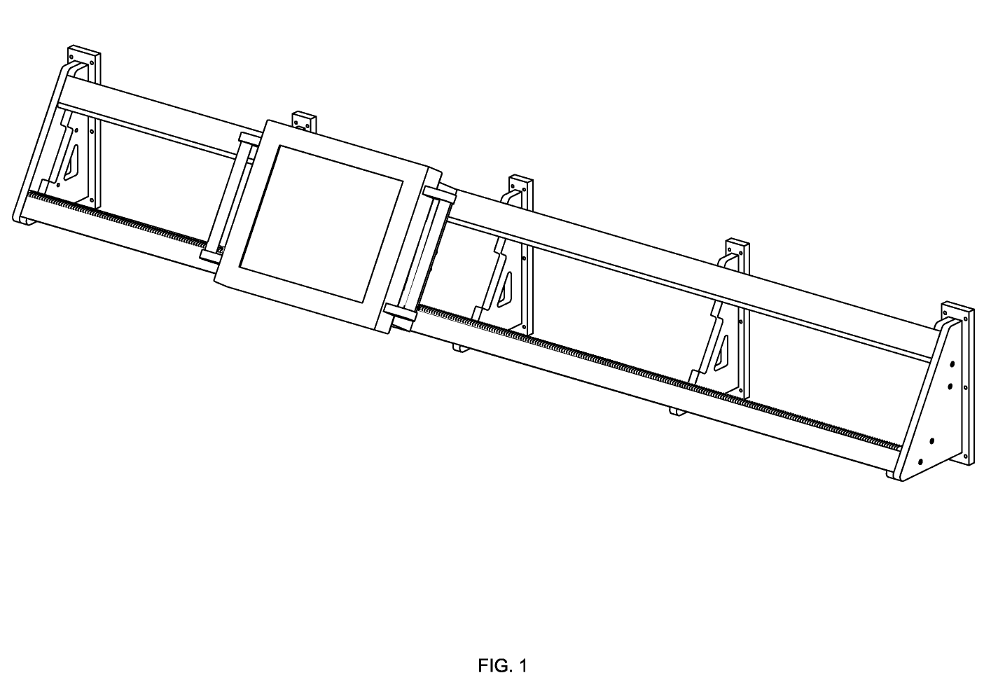

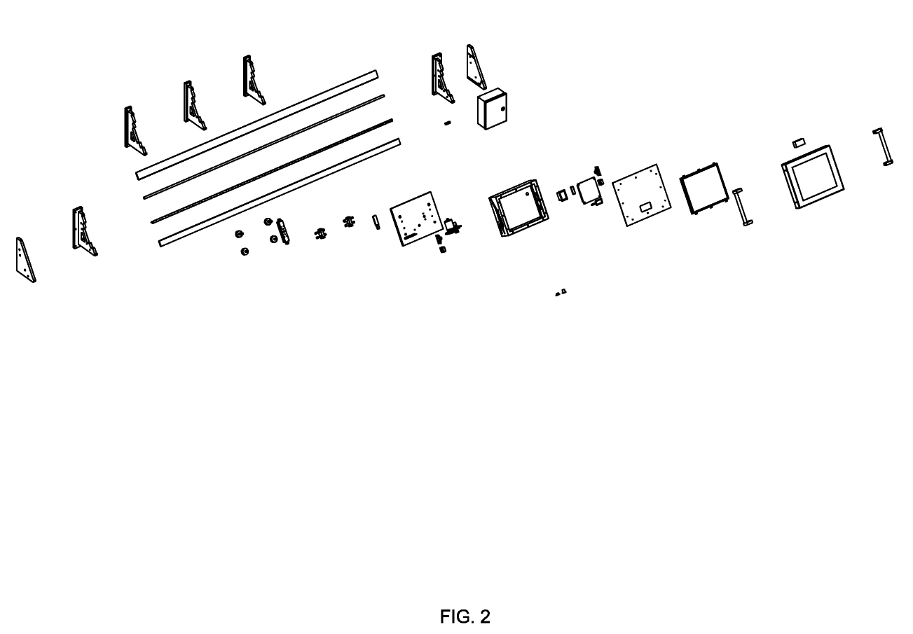

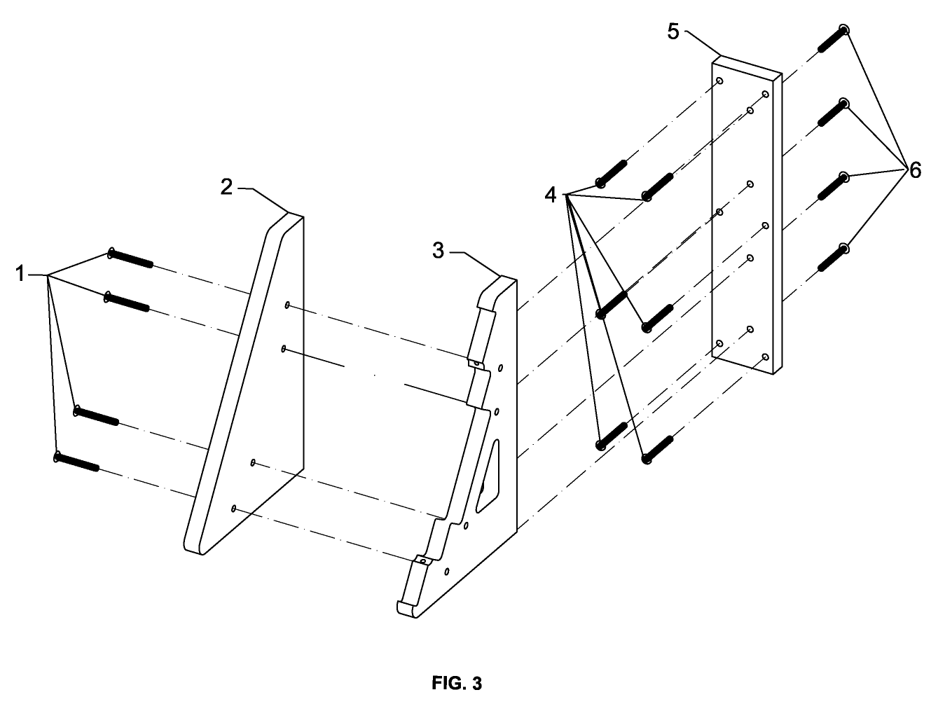

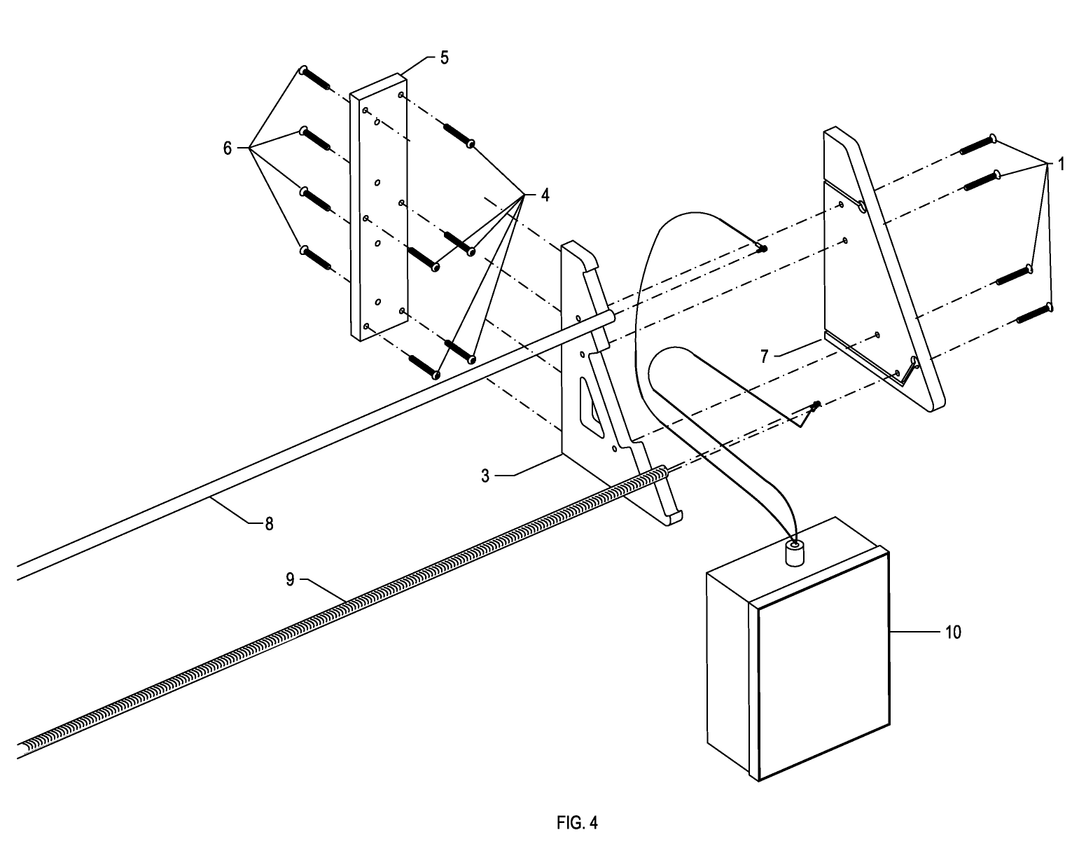

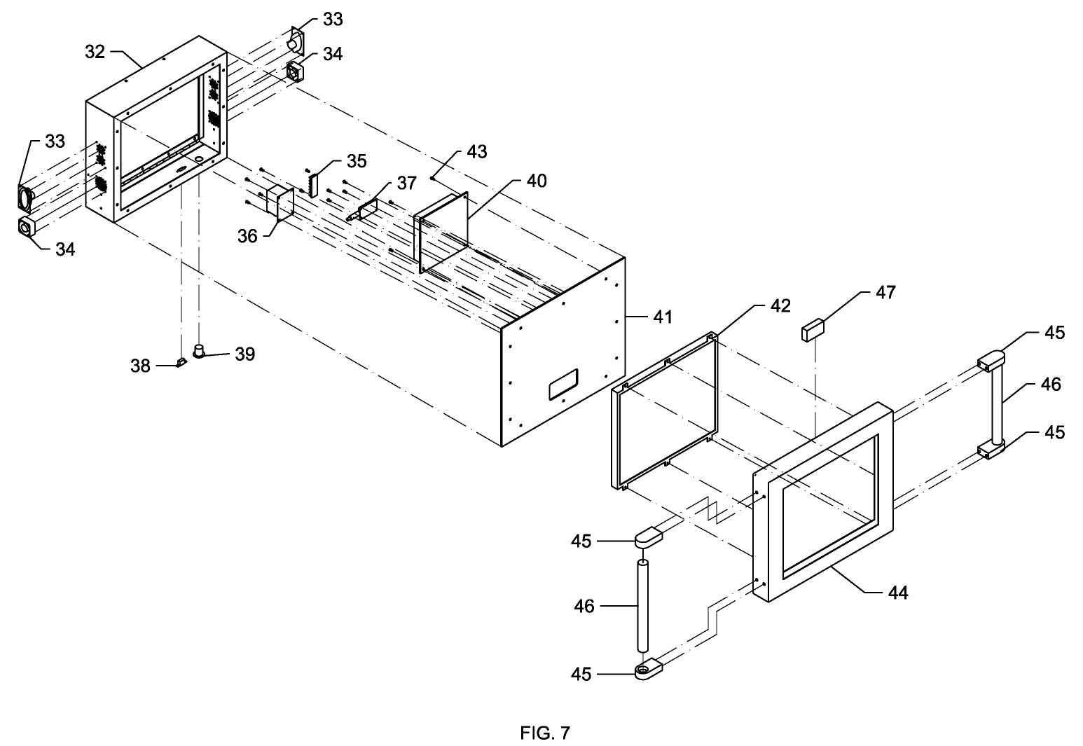

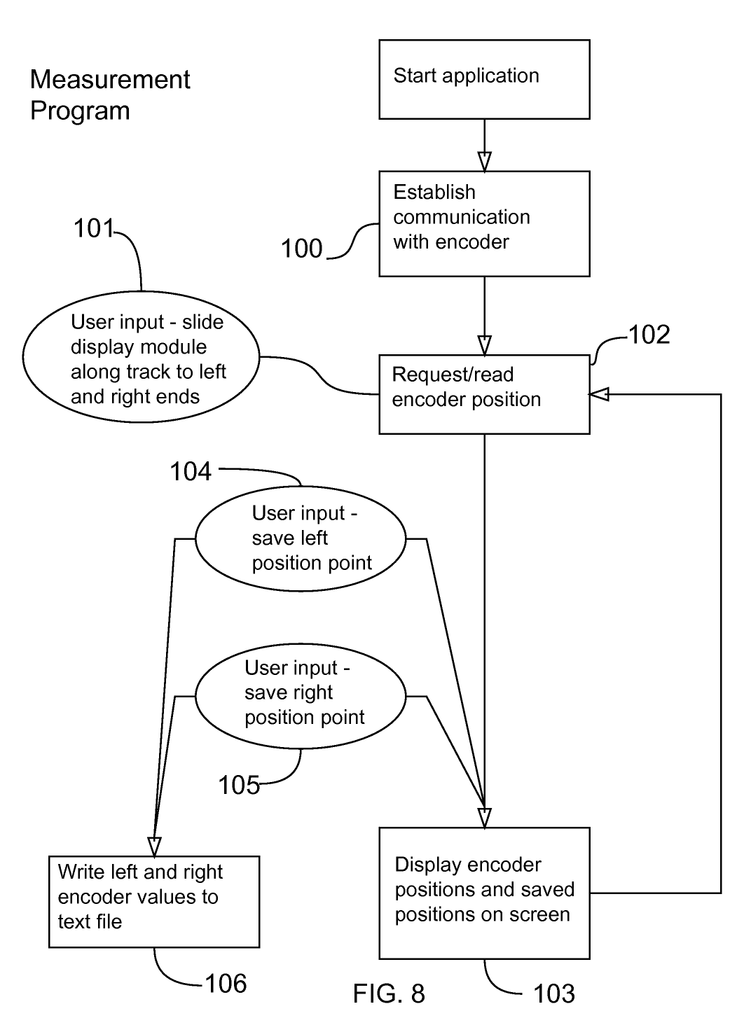

Reference numerals for FIGS. 8, 9, and 10 are found in the Sequence Listing section above. The numerals below occur in FIGS. 1-7.
1. Machine screws
2. Non-conductive end cap (in an embodiment, strong shock-resistant acrylic), without power runs
3. Standoff mount with mounting holes for end cap
4. Machine screws
5. Non-conductive mounting plate for end standoff, wide
6. Machine screws
7. Non-conductive power side end cap with channels for power runs
8. Upper round support/power rod (rail)
9. Lower Round support/power/rack gear rod (rail)
10. Remote 12 VDC power supply
11. Non-conductive mounting plate for standoff, standard
12. Standoff mount, standard
13. Pinch guard
14. Copper pick up
15. Spring
16. Power pickup base
17. Power pickup cover
18. Absolute multi turn encoder
19. Gear to engage # 9 round rack gear
20. Complete power pick up
21. Non adjustable “V” rollers
22. Adjustable “V” rollers
23. Shock mount
24. Shock absorbers
25. RF wireless data link
26. Load cell
27. Electrical grade fiberglass back plate
28. Nuts for rollers
29. Machine screws
30. Encoder mount
31. Encoder spring
32. Back box with hinge for back plate
33. Audio speakers
34. Cooling fans
35. Load cell interface
36. Audio amplifier
37. Encoder interface
38. USB Connector Jack
39. Key Switch
40. CPU
41. Monitor box back plate
42. Computer monitor with touch screen
43. Machine screws
44. Monitor box
45. Handle standoff mounts
46. Handles
47. Camera/card reader

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. Furthermore, it can also be apparent to those skilled in the art that such components, regardless of how they are combined or divided, can execute on the same computing device or can be distributed among different computing devices connected by one or more networks or other suitable communication mediums.

In accordance with the embodiments, systems and methods are described for an interactive device designed for dynamic information display and control. A movable display module is mounted on and can be moved along rails. The rails serve four purposes:

1. to provide DC power, and in some embodiments, data, to the movable display module;
2. to act as a rack gear for absolute encoding of physical position of the movable display module along the rails;
3. to provide physical support for the movable display module; and
4. to act as guide tracks for the motion of the movable display module.

As a user slides the movable display module along the rails, a computer program interprets the sensor data from the motion and presents the appropriate programmatic content on the display module. Other sensors may contribute to the computer input; and other displays or external effects may be controlled by the computer program as well. The movable display module comprises an enclosure, a touch screen and monitor, CPU, absolute encoder and encoder interface, audio amplifier and speakers, a radio frequency wireless network connection (WiFi) mounted on non-conductive material, and other sensors such as, but not limited to, cameras, smart card readers, and load cells.

As a result of the power delivery through the rail system and the inclusion of the wireless data network connection device, no cabling is required to travel with the movable display module, substantially improving robustness of the system over prior art. As a result of the rack gear and absolute encoding system, the system retains its position data and does not require recalibration after powering down, which is also a substantial improvement over prior art.

Movable displays are useful and have commercial application in any case where the creation of a compelling physical/digital interaction experience is desired. Properly designed, a movable display provides a dynamic wealth of information in relation to physical objects, positions or places. We identify several industries where this embodiment can be useful, including:

a) a museum or trade show exhibit platform, in lieu of standard signage or stationary computer kiosks;

b) an interactive educational platform for classrooms, learning centers, or for executive briefing centers;

c) an instrument for complex data visualization for medical diagnostics or in command and control centers; or

d) an interactive presentation device in commercial venues such as malls, showrooms, or stores.

Here we describe some example use scenarios, which are examples for illustrative purposes only and are not intended to limit the scope of the invention:

In an automobile showroom, a movable display module can be moved along its rails that are set in an arc around a new car, in order to show pertinent details of the construction and operation of the vehicle. As the module is moved past a particular section of the car such as the engine, details about that section are shown on it.

In a museum, a movable display module may be mounted on its rails against a wall on which a timeline is displayed. As the movable display module is moved past a certain date, information relating to events that happened on that date appears on its screen. If that embodiment includes a second display, dynamic information may be projected onto the wall as well.

In a store or shopping mall, a movable display module on its rails may be attached to a glass cabinet in which goods for sale are offered. As the display moves in front of each item in the cabinet, details about the object appear on the display.

In any of these cases, if more in-depth information is desired, video or hyperlinks are available via the touch screen on the display. The Control Program may send information to external displays, effects, or systems as well as to the movable display module. For example, the wall against which the rail system is mounted may show a large projected display with content that is controlled via the Control Program; or an external camera may be mounted on a robotic swivel or track which may be controlled via the Control Program.

Reliability, safety, ease of use and maintenance are major issues in the design of devices for public exhibition spaces as well as other venues. In addition, new means for displaying and interacting with information is of value in many environments. The present invention leverages the advantages of physical interaction and dynamic display of content. Particularly in venues such as showrooms, sales floors, tradeshows, or museums, capturing and holding a visitor's attention is paramount. Standard unmoving signage (usually printed or painted) does not change its content and is therefore very limited in scope. It lacks moving content and the ability to be updated frequently or in response to immediate context, and is not interactive. An immobile video display may interactively change its content, but it does not provide the visceral sense of personal, physical control that is created by the compelling experience of the movable display. The physical action by the human creates a personal experience of the connection between the real world object (such as an artifact or a spot on a timeline) and the digital information presentation related to that object as shown on the displays and/or effects of the invention.

The first embodiment of the present invention is a movable display module that runs on rails (typically mounted to a wall, panel, or support framework). The movable display module (for example, a color LCD touch screen, with a thin, small computer mounted behind it, and associated electronics for position encoding and other sensors, audio playback, and network communications), is mounted in a frame with (e.g. two) handles. The framed monitor is mounted on a pair of conductive (for example, steel) rails such that the monitor can be moved back and forth along the rails. The rails can vary in length. Sections may be linked together to allow a longer rail run, up to thousands of feet. One rail serves as the absolute positional encoder rack gear track for the device; it has finely machined cuts in the steel to engage with an encoder mechanism. Four “V” roller bearings hold the movable display module onto the rails.

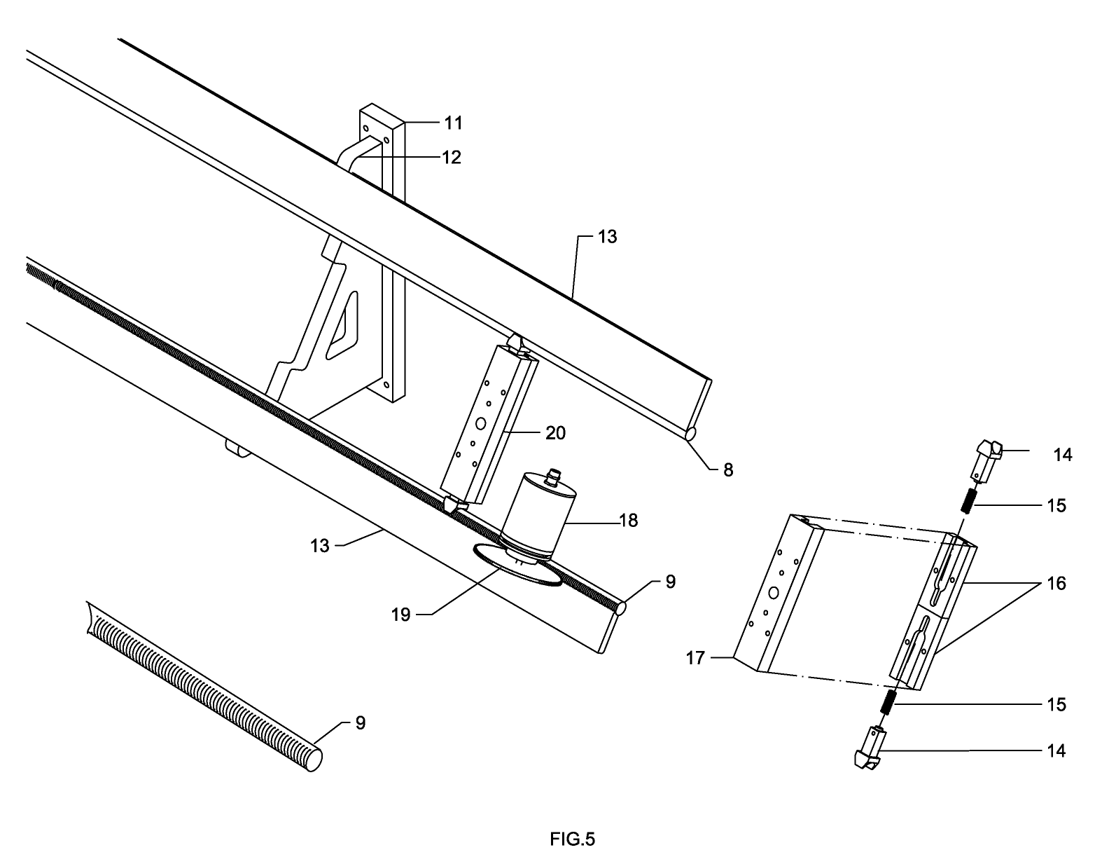

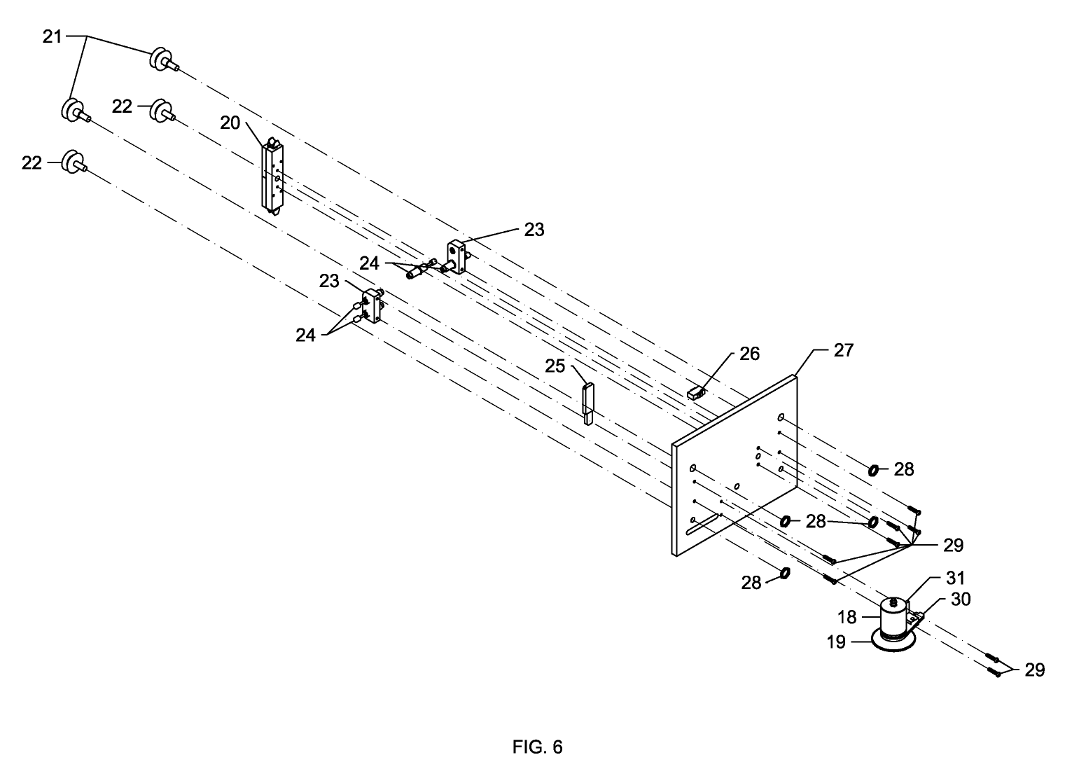

Power for the movable display module is delivered through the rails, so that no trailing cables or a cable management system are necessary. Power for the equipment in the movable display module is provided through a unique power pickup design, where a spring-loaded pair of conductive rods are each drilled out in a semi-circle on one end in such a fashion as to fit snugly around approximately 50 percent of each of the round conductive support/guide rails. This provides a large contact area, increasing the reliability of power to the system. The conductive rods are mounted held snugly against the support rails by the spring-loading. (See detail drawings of the power pickup, encoding rack gear system and “V” roller bearing design in FIGS. 5 and 6.)

Because the power running to the system is run through the rails, it is possible that something conductive laid across both rails could short the system power, just as it would on a toy train track. The system is designed to handle this safely, and to reboot automatically right back into its previous state in the event this happens, even if the display module has been moved.

The rail system with the power pickup and rack gear are self-cleaning in three ways. First, the “V” bearings are self-cleaning as opposed to systems like recalculating ball bearings or sleeve bearings that get quickly fouled in public spaces like museums (by things like sticky fingers, or by chewing gum that kids stick on the rails). The system is self-cleaning along the rack gear rail as well, in that the act of moving the gear along the rail helps clean the machined cuts, so that there is no dirt buildup over time to impede the operation of the system. Finally, the spring-loaded conductive rods on the power pickup are tightly fitted to the rails, and push foreign material away from the rail surface as they move over it.

The movable display module has an onboard wireless data connection for an external network (WiFi) and can be connected to a local or distributed computer network, allowing remote control and remote content replacement or updating. The antenna for the radio frequency network is placed on a non-conductive back plate at the rear of the display module's enclosure, so that interference from the surrounding metal is at a minimum. The system also includes a radio frequency remote monitor link.

Several other kinds of sensors (e.g. positional, infrared, image, auditory, and pressure), in addition to the touch screen on the monitor, send data to the onboard computer. These sensors may be actively controlled by a human user, or they may be passive sensors picking up environmental and contextual data. The computer shows on the monitor different information based on the position of the monitor on the rails, and on other sensor data as it is picked up by the system. The information shown may be graphics, live or recorded video, text, and/or audio, among other things.

The software for receiving and interpreting sensor data is on this machine, as well as the software for displaying the interactive content (graphics, e.g.) and software and hardware for communicating via wireless network with other devices or systems. There is also a USB (Universal Serial Bus) connection jack for local uploading; and a key system for secure system startup.

The system can control external systems or devices based on the interaction and sensor data it receives, such as robotic cameras, light displays, or external monitors. For example, as a user moves the device horizontally to the right or left, a set of light panels mounted on the wall above it could turn on and off in response to the horizontal movement of the device's monitor. Or, a user may use a graphical widget on the touch screen to control a remote robotic camera. In this manner input from any of the sensors may be used to control a variety of external devices or systems, using an aspect of the same software that controls the interactive content. A radio frequency link (separate from the onboard WiFi) can send video signals to external displays.

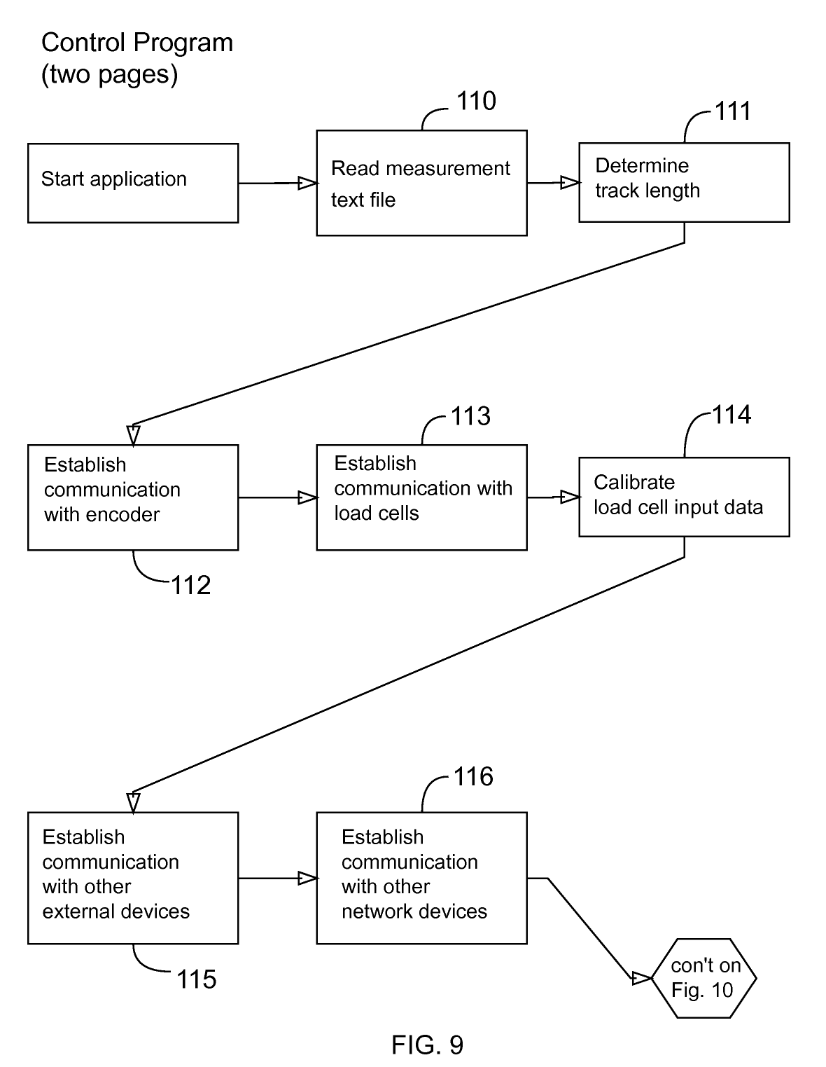

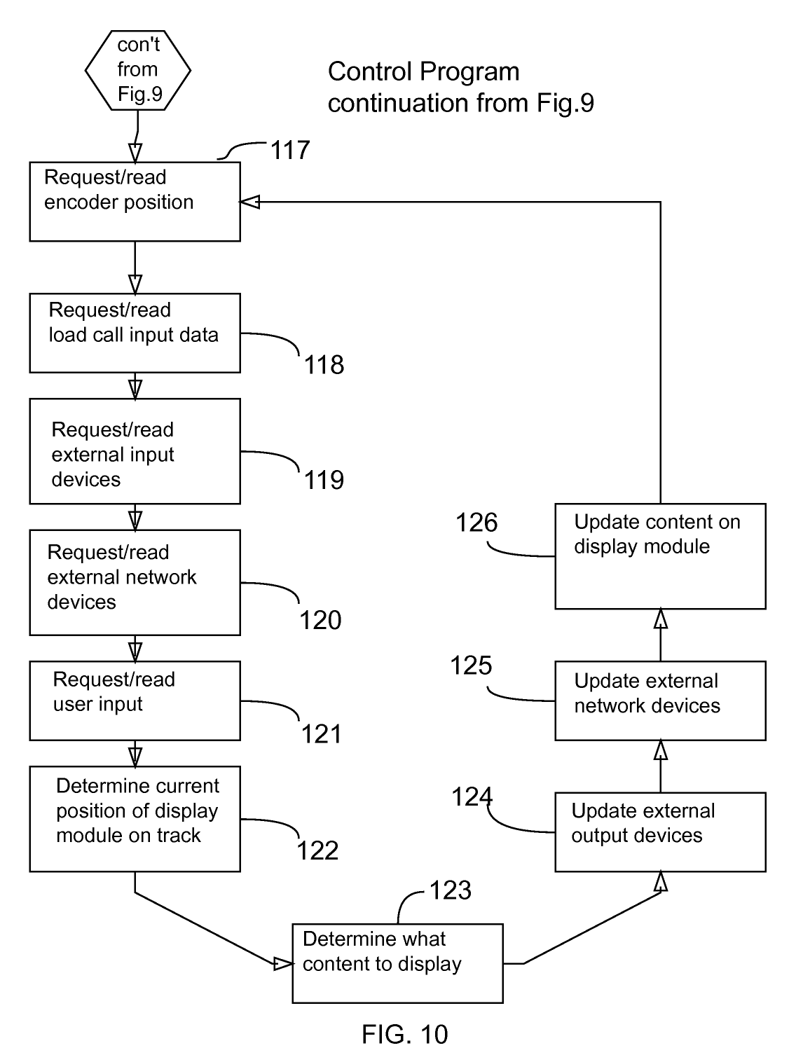

A hardware description of a first embodiment follows, as shown in FIGS. 1-7, with numeral references. Two rods made of or incorporating conductive material (8, 9) are mounted on non-conductive standoffs (12) attached to a wall, panel, or frame (11). Attached to the rods is a DC power supply providing for example, 12 volts DC (10). A power pick up (20) is mounted on the back of a non-conductive back plate (27) that transfers power from the rods (8, 9) to: a CPU (40), a computer display with a touch screen (42), an audio amplifier (36), an encoder (18), an encoder interface (37), a load cell (26), a RF (radio frequency, for example, WiFi) data link (25), cooling fans (34), a camera/card reader (47). The combination of power delivery through the rods and data delivery via RF/Wifi create a cable-free power and data delivery system, eliminating the need for cables and a cable management system which historically have been a major point of failure in earlier related systems. The bottom rod (9) has a rack gear cut into it engage the gear (19) that drives the encoder (18). The encoder has an encoder interface (37) that feeds the gear's location to the CPU (40) on the rods (8, 9). The CPU (40) processes the location information and maps it to the desired programmatic response, which is then sent to the computer display (42). The predetermined content for that location of the gear (19) on the rod (9) can reliably be experienced by repeating the encoder (18) motion. The touch screen (42) provides another sensor interface to the programmatic content. Another sensor, a load cell (26) is attached to the back plate (27) and back box (32) and when pushed or pulled also provides sensor information that is sent to the CPU (40) via a load cell interface (35). The Control Program (FIGS. 9, 10) on the CPU (40) sends audio signals to the audio amplifier (36) that drive the audio speakers (33). Two fans (34) keep the CPU (40) cool. A wireless RF interface (25) is linked to the CPU (40) for sending and receiving data via an external network. Mounted to the non-conductive back plate (27) are four “V” groove rollers (21, 22) that engage the rods (8, 9) so the boxes (44, 32) can move freely from left to right. Four shocks (24) are mounted in shock mounts (23) attached to the non conductive back plate (27) to soften the stop when the shocks hit the either left or right end caps (2 and 7). Mounted on the monitor box (44) and connected to the CPU (40) are a video camera and smart card reader (43) which serve as another set of sensors for determining programmatic content.

The current embodiment comprises a number of solutions to noted problems, making it substantially more robust and reliable. It includes more and more effective interaction capabilities than the earlier systems. It is also more adaptable to differing physical contexts, and is much less expensive (less than half the cost of competing systems).

Advantages of the current invention in comparison to prior art are noted in detail below, and include a system for absolute rather than relative positional encoding; substantially increased robustness due to wireless operation and the use of hardier components such as flash drives; ease of maintenance including wireless communication with the ability to update content and programming remotely; an extended sensor suite for more compelling interaction combinations; and streamlined production enabling a substantially lower cost to the product. In more detail:

All of the prior art systems required electrical and data cabling to travel with the movable display in its motion, and all used a cable management system. However, any moving cable system will be less robust than a system without moving cables, as repetitive flexing over time degrades the cable. The current embodiment avoids cable failure associated with motion two ways: first, it delivers DC power through the rails the movable monitor module slides along (much as a toy train's rails do). Second, data for the content is either contained in the onboard computer's flash drive, or loaded via USB jack, or delivered through a wireless network (in the case of web content, for example). The current embodiment has no need for moving cables at all, making it much more robust.

Most prior art devices did not have any interaction available other than the sliding motion. Our current embodiment has a touch screen for more personal and deeper interaction such as starting and stopping videos, following hyperlinks, or using a soft keyboard, and a load cell for controlling a Z-axis dimension in the onscreen graphics (X-axis is the along the rail track). Other embodiments of the current invention add other sensors and controllers such as cameras, microphones, or physical controls.

Onboard computer: The current embodiment is self-contained, with a specially designed onboard CPU, providing much greater ease of installation. Though one of the prior art systems also used an onboard computer, it was a standard model, and used standard hard drives which may fail when continually exposed to motion, especially if the brakes fail and they are subject to hard shocks. This creates a hazardous environment for the hard drives that computer used, and made them prone to failure. Our embodiment uses fast flash drives instead of hard drives, which are much more robust.

None of the prior art used an absolute encoder, but read position a) using a simple encoder along a steel tape, or b) using a series of switches along a track, or c) by measuring the relative number of clicks along a track from a starting position, using an incremental encoder, or d) using other kinds of incremental encoders. All these prior art systems needed to be manually recalibrated each time they were turned on, at the beginning of each day, and in the event of power failure. The current embodiment uses an absolute multi-turn encoder for precision repeat accuracy in reference to location on the rail system so that the system does not lose position information when it is shut down, and automatically loads the correct position information when it powers up again. In addition our embodiment can use a reset switch in the rail for the encoder if more than a thousand-foot run is desired, so that very long rail lengths are possible (several thousand feet).

Mass and support framework: several prior art systems used large plasma monitors, which were heavy for users to drag along the track and which required heavy-duty support systems. The plasma monitors and the required supports were expensive. Our embodiment is designed to be much lighter weight and easier to move, with a smaller monitor and therefore less support structure. This means our embodiment can be used in more ways, in smaller spaces, and also is less expensive, which makes it appealing to designers.

Ease of production: Most of the prior art systems are produced as site-specific instances, which adds considerably to their cost. Our embodiment is deliberately designed for mass production, including modularity, extensibility, adaptability to context, and ease of setup (one or two hours in most cases). Aspects of the streamlined production process include CNC (computer numerical controlled) milling for exactly replicating parts, and a custom-designed CPU motherboard. Seventeen of the first embodiment's parts are uniquely computer-designed and computer-cut, and thus can be replicated at will; the rest of the parts are readily available off-the-shelf. As an example, the CPU motherboard for the first embodiment is specially configured with: a flash drive interface rather than the standard hard disk drives, for durability; GPIO (General Purpose Input or Output) ports for sensor handling; 12 VDC power only (no need for the usual 5 VDC plus 12 VDC power found on most motherboards); 3 gigabytes RAM capability; USB 2.0 and RS-485 serial interfaces; a Duo Core CPU; a PCI+16 accelerated video slot; and onboard WiFi.

Ease of travel and installation: The modularity of the support system and other components makes the current embodiment much easier to use as a traveling exhibit. The components can be packed and shipped more easily, and replacement or spare components are much cheaper. Installation time is substantially less (about an hour in most cases) and can be done by does not require expertise or special training.

Configurable geometry: previous systems of which we are aware are fixed in straight lines with limited travel, or in very gentle curves. In contrast, our embodiment can be configured with much tighter convex or concave curves in the rails, allowing oval or round shapes. The rails come in standard sections that can be added on for desired length, up to multiple thousands of feet. The rails can be vertically offset from each other to give a desired angle of view position to the module, or the module can be mounted on a tilting or twisting hinge for a personally adaptable angle of view.

Braking: Large and heavy expensive displays need a way to stop them at end of travel. A particle brake and shock system was used in the design for several prior art systems. Particle brakes are costly, have high drag when not engaged (and are therefore make the system harder to use), and are a repeated source of failure in respect to the gear engagement to the track. Our embodiment uses a smaller, lighter monitor/computer system that reduces the heavy mass at the stop at end of travel. Less mass means no need to use a particle brake; the shocks alone stop the display module. In tests we found that one shock will stop the display module, but we use two in each direction in the event that one fails. This design reduces cost and increases both usability and reliability of the system.

Some prior art systems are designed to perform X-Y (horizontal-vertical) movement in real space, using support rods rather than tracks or rails. These systems have a number of moving parts and are less reliable then a single axis system. In addition the logic of the Y-axis interaction does not provide the richness of detail that a Z-axis interaction can. The current embodiment uses load cell sensors to supply Z-axis (zoom, or depth) information. These sensors are much more reliable and the use of Z-axis interaction instead of Y-axis maps well to “level of detail” queries such as zooming in to a place on a map, a part of an object, or a period of time in a timeline. With the load cell sensors, a user can gently “lean into” the display module to effect a zoom interaction. If the user leans harder on one side than the other, then a “steering” effect occurs (very useful for astronomy exhibits, for example). The force data can also be mapped to create apparent Y-axis motion, if the content is such that this mapping makes sense.

Safety: This embodiment (and all embodiments) complies with U.S. regulations and recommendations for safe usage in low power electrical systems. In this embodiment, DC power is delivered through conductive rails, much as it is in a toy train system. In fact the amount of power required by the movable display module is less than that provided by some commercially available, UL-approved toy train transformers. The movable display module is mounted on the conductive rails and can slide along them easily, with a push or pull. Therefore, no matter where the display module is on the rails, it has an uninterrupted power supply.

We describe several additional embodiments:

an additional embodiment in which the power means is inductive, comprising an inductive coil mounted in said movable display module and another set of power coils distributed along the framework, such that power is transferred to said movable display module inductively as it moves along the rails.

an additional embodiment in which the movable display module's computer controls remote monitors in addition to its own monitor, using a radio-frequency monitor connection.

an additional embodiment in which the means for absolute position encoding consists of an image-capture system marking position in relation to visual cues such as bar codes or patterns, or visual recognition of its position in relation to an object or environment.

an additional embodiment in which the power means is provided to the power rails or inductive system from a solar power collection system.

an additional embodiment in which the power means is a long-life battery or rechargeable battery system.

an additional embodiment in which the data exchange means is provided as a carrier signal along the power rails.

an additional embodiment in which several of said movable display modules are mounted within the same framework.

an additional embodiment wherein the rails are embedded into a panel, wall or cabinet rather than mounted on standoffs.

an additional embodiment wherein the framework and rails can be constructed and connected in differing geometric configurations, allowing for example an oval-shaped motion pathway for the movable display module.

an additional embodiment that uses load cell sensors to supply Z-axis (zoom, or depth) sensor data, mapped to “level of detail” queries such as zooming in to a place on a map, a part of an object, or a period of time in a timeline.

an additional embodiment that uses load cell sensors to note the difference in Z-axis data if the user leans harder on one side of the movable display module than the other, creating a “steering” effect.

FIGS. 1 through 7 are exemplary illustrations of various devices and components within the context of various embodiments. Although these diagrams depict components as logically separate, such depiction is merely for illustrative purposes. It will be apparent to those skilled in the art that the components portrayed in this figure can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication mediums.

As illustrated, the system can encompass a variety of computing, sensor, display and image capture devices. Image capture devices can include digital and analog cameras, video recording devices, and other devices capable of capturing still photographs or moving images. In some embodiments, additional hardware can be utilized such as eye-tracking apparatuses, motion sensors, data gloves, audio capture devices and the like. The connection can be any communication link established between two or more computing devices, including but not limited to local area networks (LANs), wide area networks (WANs) such as the internet, wireless connections (including radio frequency-based, microwave, or infra-red), cellular telephone communications and other electronic communications.

FIGS. 8, 9, and 10 are exemplary illustrations of a software control and calibration system, in accordance with various embodiments. Although these diagrams depict components as logically separate, such depiction is merely for illustrative purposes. It will be apparent to those skilled in the art that the components portrayed in these figures can be arbitrarily combined or divided into separate software, firmware and/or hardware. Furthermore, it will also be apparent to those skilled in the art that such components, regardless of how they are combined or divided, can execute on the same computing device or can be distributed among different computing devices connected by one or more networks or other suitable communication mediums.

It should be noted that these models are provided purely for purposes of illustration and that many different models can be implemented within the scope of the present embodiments.

Various embodiments of the invention described above include a computer program product that is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions that can be used by one or more processors to perform any of the features presented herein. In various embodiments, the transmission may include a series of multiple and separate transmissions.

Stored in one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

The computer program description is included here for completeness. A person skilled in the art can construct the necessary software for the first embodiment from the following program descriptions.

The following is the logical description and flow of the software programs required to run a first embodiment of the current invention. This information appears in flowchart form in FIGS. 8, 9, and 10. The software contains several programs for different tasks, as noted. In other embodiments, similar routines may control other aspects of the embodiments.

Measurement Program: The Measurement Program is a software program used to measure the range of motion the movable display module will travel, and mark its endpoints. In order to calibrate the software so that it is aware of its position on the track, the measurement software must be run so that the left endpoint and right endpoint numeric encoder positions of the track can be determined. Once the left and right endpoint positions have been recorded, the software will know the physical position of the movable display module along the rails, even if the unit loses power. The position is stored in a text file that is read by the Control Program. This needs to be done once when the device is first activated, and again if the movable display module is removed for service.

Start Application:

100. Establish communication with encoder. Open the communication port and protocol for the reading/writing of data to/from the encoder. This includes, but is not limited to: serial RS232, RS485, and TCP/IP.
101. User Input—Slide the movable display module in each direction along the track. When the user physically moves the movable display module back and forth on the track, the encoder updates the current position.
102. Request/Read encoder position. A request message is sent to the encoder, and the reply message is parsed to decipher the numeric encoder position value, stored as an integer.
103. Display encoder position on screen. The user interface of the program displays the last known (current) numeric encoder position, as well as the values in memory of the “leftpoint” and “rightPoint” variables defined by user input (104 and 105).
104. User Input—“Save Left End Point Position”. The user slides the movable display module to the leftmost physical endpoint and clicks a graphical button on the touch screen interface to mark the current encoder position as the “Left Point” on the track. This position data is updated in the measurement program memory and displayed on the interface screen. This user input also triggers the recording of this information into a text file (106) as “leftPoint”.
105. User Input—“Save Right End Point Position”. The user slides the movable display module to the rightmost physical endpoint and clicks a button on the interface to mark the current encoder position as the “Right Point” on the track. This position data is updated in the measurement program memory and displayed on the interface screen. This user input also triggers the recording of this information into a text file (106) as “rightPoint”.
106. Write leftPoint and rightPoint data to text file. This records the two marked encoder positions into a text file for future reading by the system's Control Program (see next listing, and in flowchart form in FIGS. 9 and 10).

Control Program: The Control Program controls the display of information based on the position of the movable display module, using the stored position data from the Measurement Program. The Control Program also requests data from external sensors and inputs, and controls digital and analog outputs. Additionally, the Control Program reacts to user interface commands or input via other sensors, including but not limited to touch screen input, smart card reads, and image or voice capture.

Start Application

110. Read range measurement text file
110a. Open text file with stored “leftPoint”/“rightPoint” encoder positions
110b. Read and store in memory the numeric positions
111. Determine total rail length
111a. Determine the numeric track length in encoder units by subtracting the “leftPoint” from the “rightPoint”.
111b. The resulting number is the total number of encoder units that the movable display module may traverse along the rails. Store this number in memory.
   112. Establish communication with encoder. Open the communication port and protocol for the reading/writing of data to/from the encoder. This communication may include, but is not limited to: serial RS232, RS485, USB, and TCP/IP.
   113. Establish communication with load cells: Open the communication port and protocol for the reading of data from the load cells. This communication may include, but is not limited to: serial RS232, RS485, USB, and TCP/IP. These signals may be routed through an analog to digital input signal converter.
   114. Calibrate load cell reading
114a. Send a request message to the load cell input and read the numeric load cell reading.
114b. Repeat 100 times to determine a statistical average input.
114c. Use this numeric average as a baseline to compare future input readings against.
114d. This process may be repeated periodically by the software.
   115. Establish communication with other external devices as needed. These external devices include, but not limited to: external monitors, media playback devices, motion controllers, actuators, sensors, Radio Frequency Identify (RFID) readers, barcode scanners, microprocessors, video input devices, lighting controllers, digital input/output controllers, and robotics. Communication methods may vary depending on situation.
   116. Establish communication with network devices. These may include, but not limited to: Internet and Local Area Network (LAN) servers, web services, syndication feeds, databases, mobile devices such as cellphones or small computers, and remote video/audio/multimedia. Communication methods may vary depending on situation.
   117. Request/Read encoder position
117a. A request message is sent to the encoder, and the reply message is parsed to decipher the numeric encoder position value.
117b. Store results in memory for use during determination process (123)
   118. Request/Read load cell input
118a. A request message is sent to the load cell, and the reply message is parsed to decipher the numeric load cell input.
118b. Store results in memory for use during determination process (123)

### 119. Request/Read External Input Devices

119a. The appropriate messages are sent to all external input devices, such as sensors, RFID/barcode devices, video input, buttons, etc.
119b. Store results in memory for use during determination process (123)
   120. Request/Read Network Input devices
120a. The appropriate messages are sent to all external network inputs, such as web services, feeds, video, database, etc.
120b. Store results in memory for use in determination process (123)
   121. Request/Read User Input. Record any user input, for example, touch screen input, image capture, or smart card swipes.
   122. Determine current position along track
122a. Subtract the saved “leftPoint” encoder position from the current position to determine the relative position.
122b. Determine the percentage moved by dividing the relative position by the total track length measurement.
122c. Store results in memory for use during determination process (123)
   123. Determine display content based on new input parameters above. Depending on the software content, this step uses the stored input from all input devices to determine how to update the display content on the movable display module, as well as external output and network devices. This process will vary based on the application and the combination of sensors and external devices.
   124. Update External Output Devices. This step sends command messages to external output devices, such as, but not limited to, turning on/off TTL logic outputs, triggering media players, updating external monitor content, and controlling actuators.
   125. Update External Network DeviceSend command messages to external output devices, such as, but not limited to, update database content, request new content source.
   126. Update display graphics and other content on movable display module.

What is claimed is:

1. a machine, providing means for physical interaction with computer-mediated information, comprising:
a system of claim 1, providing a movable display module comprising:
a means for computation such as a computer CPU and memory and for information handling such as software appropriate to the method and functions desired, and
capable of programmatically mediating presentation materials both on said movable display module and external to said movable display module;
at least one computationally addressable display means and framing for said display means;
a means for said movable display module and absolute positional encoding of said movable display module, such that position and calibration information is retained when power is lost or turned off,
a means for physical interaction and for sensing said interaction such as sensors and encoders, touch screen, load cell, physical buttons or continuous controllers, on the interior and exterior of said movable display module or its framework;
a system of claim 1, providing a set of rails supporting said movable display module, comprising:
a means for connecting said set of rails to said movable display module;
a means for providing power through said set of rails, said rails being made of conductive material and attached through their standoff support to a power source;
a means for providing to the computer CPU the absolute position of said movable display module on said set of rails, such as rack gear cuts in said rails and an absolute encoder and encoder interface to read said rack gear cuts;
a means for providing physical support for said movable display module and for connecting said support to said movable display module;
a means for providing guide tracks for said movable display module to move back and forth between the endpoints of its rail tracks;
a system of claim 1, providing data exchange means for communicating with said movable display module wirelessly, thus removing the need for external cabling to move along with the module, by providing a sufficiently non-conductive and non-shielded mounting arrangement for a wireless radio frequency network antenna and reception device;
whereby physical actions of a human or humans registered by said sensors upon said movable display module are interpreted by said computer and said information handling system in order to manipulate programmatically controlled digital information presented on said display means, all this being accomplished without the need for cables or a cable management system being connected to the movable display module, and with the means to retain position and calibration information when power is turned off or lost, whereby substantial gains in robustness, safety, effectiveness, and affordability are created.

2. a method for interaction with computationally-mediated information displays, comprising:
a method of claim 2, being a movable display module
providing a computationally addressable display means and framing for said display means;
providing a means for a movable display module and absolute positional encoding of said movable display module, such that position and calibration information is retained when power is off;
providing means for physical interaction and for sensing said interaction via sensors and encoders on the interior and exterior of said movable display module, such as touch screen, load cell, physical buttons or continuous controllers;
providing a means for computation such as a computer CPU and memory and for information handling such as software appropriate to the method and functions desired, and capable of programmatically mediating presentation materials;
a method of claim 2, being a set of rails for said movable display module to move upon, comprising:
a means for providing the absolute position encoding of the position of said movable display module on the rails, such as rack gear cuts in said rails and an absolute encoder to read said rack gear cuts;
a means for connecting said set of rails to said movable display module;
a means for providing physical support for said movable display module;
a means for providing guide tracks for said movable display module to move back and forth upon;
a method of claim 2, providing means for providing power to and exchanging information with said movable display module wirelessly, by providing the power through said set of rails; said set of rails being made of conductive material;
whereby physical actions of a human or humans registered by said sensors upon said movable display module are interpreted by said computer and said information handling system in order to manipulate programmatically controlled digital information presented on said display means, all this being accomplished without the need for cables or a cable management system being connected to the movable display module, and with the ability to retain position and calibration information when power is turned off or lost, whereby substantial gains in robustness, safety, effectiveness, and affordability are created.

3. a new use for the combination of cable-free structurally integrated power delivery means (via conductive rails, long-life or rechargable battery, or inductive power system), in combination with a wireless network device for data exchange, and a means for absolute position encoding, (such as an absolute encoder and a rack gear, or an image-capture system marking position in relation to visual cues such as bar codes) in conjunction with a movable display module requiring power and positional data, comprising:
a system of claim 3, providing
a cable-free means for providing appropriate electrical power to said movable display module, either by providing a means for connecting said movable display module to a set of conductive rails carrying appropriate power, or by means for providing power through induction such as appropriate coils set into a support framework and into said movable display module;
a system of claim 3, providing
a means for wireless communication and for providing appropriate data exchange with said movable display module, by providing a sufficiently non-conductive mounting arrangement for a wireless radio frequency network antenna and reception device;
a system of claim 3, providing
a means for computation such as a computer CPU and memory and for information handling such as software appropriate to the method and functions desired, and capable of programmatically mediating presentation materials;
a system of claim 3, providing a set of conductive rails for said movable display module to move upon, comprising:
a means for coupling said rails to said movable display module that is efficient for transferring both power and motion, such as properly formed and sized copper pickups;
a means for providing absolute positional encoding data, such as rack gear cuts in conductive rails and an absolute encoder for reading the rack gear;
a means for providing physical support for said movable display module and connecting said support to said movable display module;
a means for providing guide tracks for said movable display module to move back and forth upon;
whereby the robustness of said machine is substantially improved over prior art by replacing the function served by standard flexible electrical and data cables with structurally strong and integrated power and data delivery systems.

4. a system of claim 1 in which the power means is inductive, comprising an inductive coil mounted in said movable display module and another set of power coils distributed along the framework, such that power is transferred to said movable display module inductively as it moves along the set of rails.

5. a system of claim 1 in which the movable display module's computer controls one or more remote display monitors in addition to its own display monitor, using a radio-frequency display monitor connection, or other externals effects such as robotics.

6. a system of claim 1 in which the means for absolute position encoding consists of an image-capture system marking position in relation to visual cues such as bar codes or patterns, or visual recognition of its position in relation to an object or environment.

7. a system of claim 1 in which the power means is a long-life battery or rechargeable battery system.

8. a system of claim 1 in which the data exchange means is provided as a carrier signal along said set of rails.

9. a system of claim 1 that uses load cell sensors to supply Z-axis (zoom, or depth) sensor data, mapped to “level of detail” queries such as zooming in to a place on a map, a part of an object, or a period of time in a timeline, or placed such that the differential in said load cell sensors' Z-axis data if the user leans harder on one side of the movable display module than the other can be used programmatically to create a “steering” effect.

10. a method of claim 1, whereby parts and components of the machine are optimized for ease of mass production, including: physical parts being easily replicable through the use of computer-controlled milling machines, and some electronic parts including the computer motherboard being specifically designed for this use.
